(19) United States
(12) Patent Application Publication
(10) Pub. No.: US 2013/0168209 A1
(43) Pub. Date: Jul. 4, 2013

(54) Grain conveyor with high lift belt

(71) Applicants: Benjamin Fanshier, Dodge City, KS (US); Ronald L. Marler, Halstead, KS (US)

(72) Inventors: Benjamin Fanshier, Dodge City, KS (US); Ronald L. Marler, Halstead, KS (US)

(73) Assignee: CRUSTBUSTER / SPEED KING INC, Dodge City, KS (US)

(21) Appl. No.: 13/374,404

(22) Filed: Dec. 28, 2011

(51) Int. Cl. B65G 15/42; B65G 15/08

(52) U.S. Cl. 198/699.1; 198/688.1

(57) ABSTRACT

A belt conveyor for grain or other granular materials has an enclosed housing, a bottom return, an infeed end and a discharge head. The conveyor uses a special high angle lift belt with projecting lugs of approximately two inches high and having cooperating angled elements that form material receiving pockets. The lugs are arrayed on the belt in meshing relationship so that as the belt curls laterally within the housing, the lugs prevent backflow of materials at least up to a forty degree angle when the conveyor is running. The bottom return section of the conveyor has a plurality of belt supporting rollers extending transversely across the return section. The belt lugs are also arranged so that upper ends of the lugs form a longitudinally and transversely continuous supportive surface for low friction running support by the belt return rollers.

### BACKGROUND OF THE INVENTION

1. Field of the Invention

The present invention relates to belt conveyors for handling grain, fertilizer and other granular or particulate agricultural and industrial products. Used by farm operators and product distributors, these conveyors move product between containers, such as from seed boxes into bins. These conveyors are often used in settings where there is limited or tight ground space and the product must be lifted to substantial height, such as from ground level into a twenty foot high bin.

2. Description of the Related Art

Belt conveyors have been used in the agricultural industry for many years, many of them pioneered by the owner herein. While these have been widely successful, there has always been limitations in vertical lift capability. While auger conveyors are useful for lift capability, augers can fracture and damage valuable seed. Using a flat belt, lift has generally been restricted to 25 to 26 degrees, with the result that conveyors have had to be made longer so that sufficient vertical lift could be obtained to deposit material in tall bins. As grain production has increased with larger yields and larger landholdings, bin height for increased capacity has also grown. As a result, the industry has seen the length of conveyors grow to as long as 95 feet. Naturally, when these ultra long conveyors are used in farm yards and seed distributor yards, ground space limitations become apparent. Additionally, ultra long conveyors are difficult to transport over roads.

Consequently, efforts have been made to increase the carrying capacity of the belt while maintaining the length of the conveyor. Special high lift belts have been designed with patterns embossed on the belt so as to increase holding area to prevent sliding of material and obtain a greater lift capacity.

In other situations, lugs have been designed and individually attached by bonding or bolting to the belt surface. Naturally, these individually attached lugs create significant expense in the production of the belt. Moreover, the more uneven the surface of the belt as created by the use of attached lugs or deeply embossed patterns, the greater is the roughness or chatter of the belt upon its return in the conveyor. The roughness and severe vibration in the belt return section can shear the belt lugs and can lead to material failure of the components of the conveyor and belt; quite literally, the conveyor can shake itself apart.

Accordingly, a need exists for a compact but high lift belt conveyor that is low friction and substantially vibration free in operation for longevity and gentleness in conveyance of costly seed or other granular material.

### SUMMARY OF THE INVENTION

A belt conveyor for grain or other granular material has an enclosed housing, a bottom return, an infeed end and a discharge head. The conveyor uses a special high angle lift belt having projecting lugs of approximately two inches high and having cooperating angled elements that form material receiving pockets. The lugs are arrayed on the belt in cooperating relation so that as the belt curls laterally within the housing, the lugs inhibit backflow of materials at least up to a 40 degree angle when the conveyor is running. The bottom return section of the conveyor has a plurality of belt supporting elements extending across the return section. The belt lugs are also arrayed so that the upper ends of the lugs form a longitudinally and transversely constant supportive surface for low friction running support by the belt supporting elements.

### OBJECTS AND ADVANTAGES OF THE PRESENT INVENTION

The objects and advantages of the present invention are: to provide an improved belt conveyor for agricultural purposes; to provide such a conveyor which is designed for a high lift belt providing a high vertical lift while being of minimal length; to provide such a conveyor which is gentle on seed or other conveyed materials; to provide such a conveyor with a belt return designed to run at low friction and substantially vibration free; to provide such a conveyor with a belt that has cooperating angled lug elements that allow a belt to curl upon entering a conveyor housing so that the lugs inhibit backflow of materials; to provide such a conveyor that will provide at least 40 degrees lift angle; and to provide a conveyor which is efficient in operation and well designed for its intended purpose.

Other objects and advantages of this invention will become apparent from the following description taken in conjunction with the accompanying drawings wherein are set forth, by way of illustration and example, certain embodiments of this invention.

### BRIEF DESCRIPTION OF THE DRAWINGS

FIG. 1 is an elevational view of a preferred embodiment of the invention and showing a high lift conveyor.

FIG. 2 is a transverse sectional view of the conveyor along lines 2-2, FIG. 1.

FIG. 3 is a longitudinal sectional view of the conveyor taken along lines 3-3, FIG. 1.

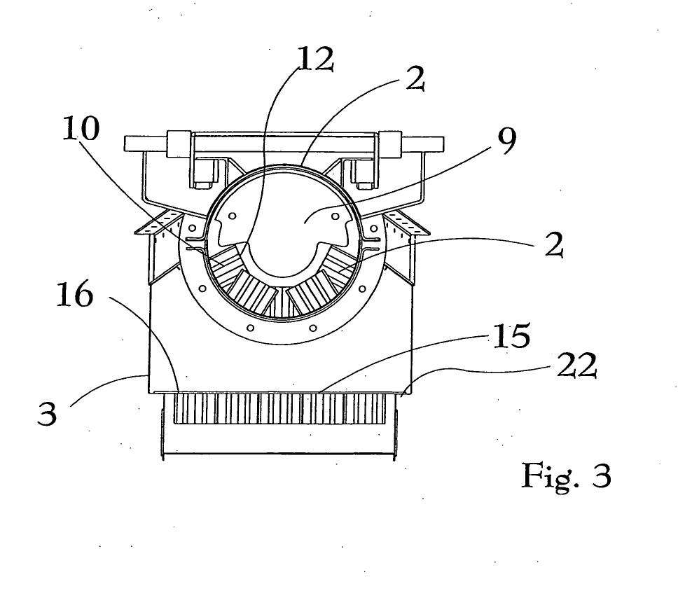

FIG. 4 is an enlarged plan view of the conveyor belt.

FIG. 5 is a transverse sectional view taken along lines 5-5, FIG. 4.

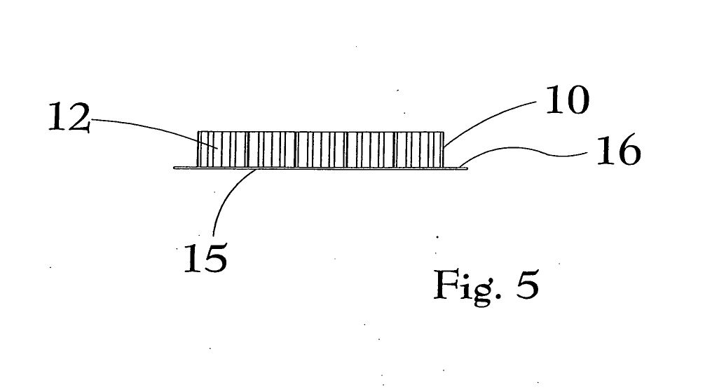

FIG. 6 is a longitudinal sectional view taken along lines 6-6, FIG. 4.

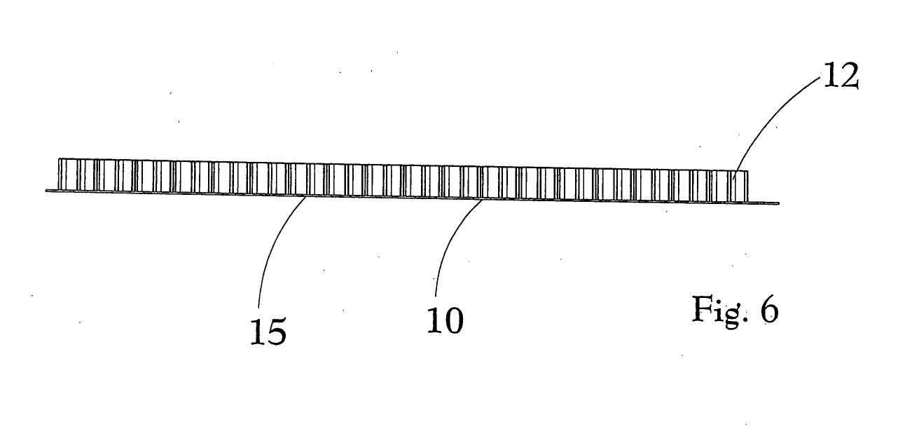

FIG. 7 is a plan view of the conveyor belt in curled relation.

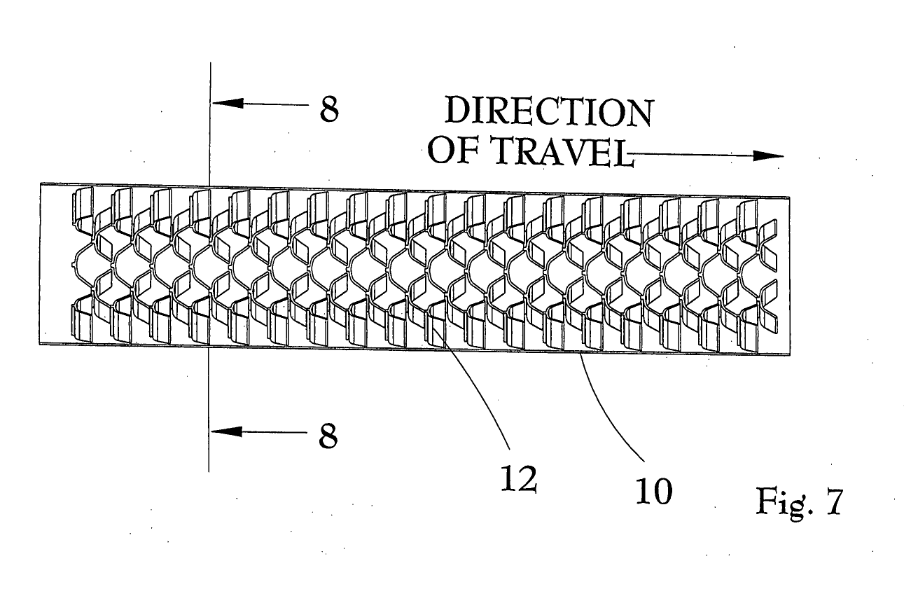

FIG. 8 is transverse sectional view taken along lines 8-8, FIG. 7.

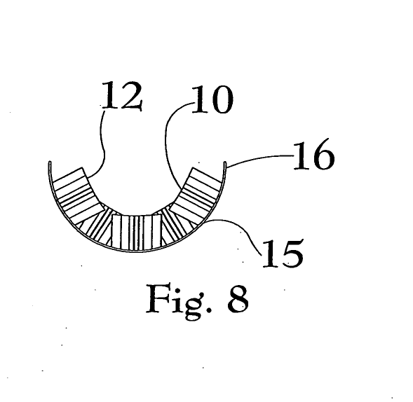

FIG. 9 is a perspective view of the curled conveyor belt.

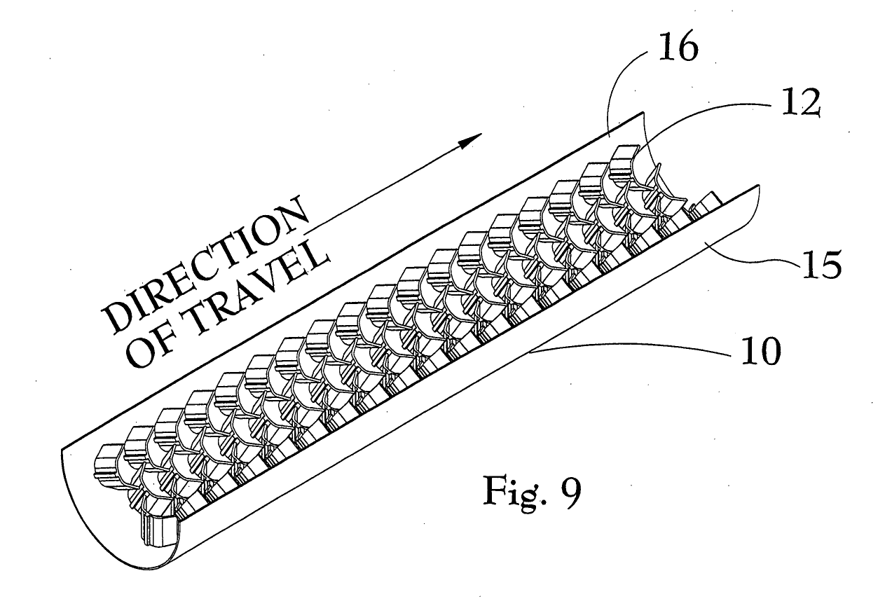

### DETAILED DESCRIPTION OF THE PREFERRED EMBODIMENT

As required, a detailed embodiment of the invention is disclosed herein; however, the invention is not intended to be limited in scope or interpretation to any particular embodiment except insofar as required under law. Rather, the disclosure embodiment is only an example, and other embodiments within the scope of the invention may be conceived after reading the disclosure or may be developed subsequently. This disclosure is intended solely as a basis for the claims, the invention being as set forth in the claims.

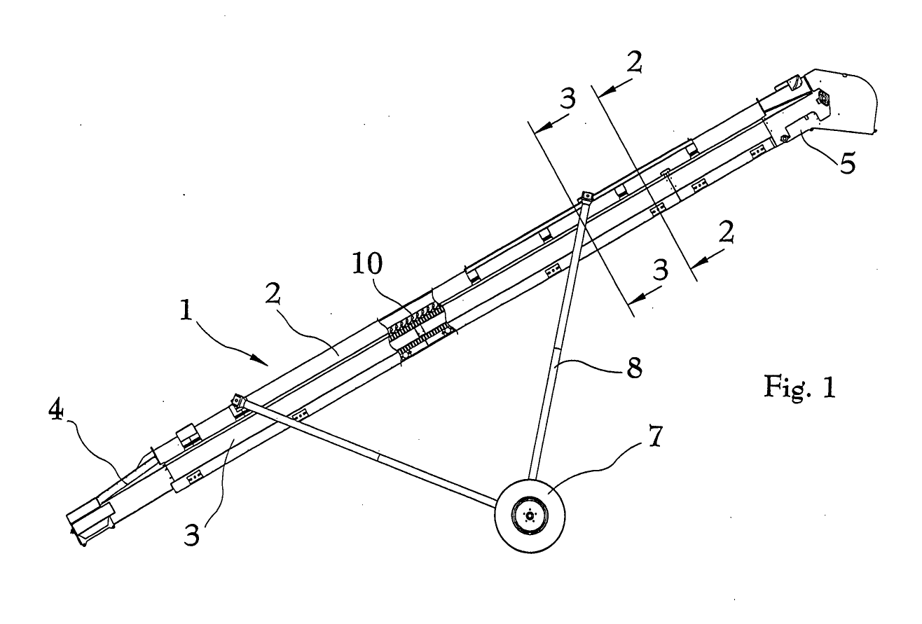

The reference numeral 1, FIG. 1, generally indicates a conveyor embodying the present invention. The conveyor 1 has an enclosed housing 2 comprising the conveyed section and a return section 3 there below. The conveyor 1 has an infeed end 4 and a discharge head 5. A conveyor drive is provided which may be of various known power units. Wheels 7 and variable height mounting structure 8 allow positioning and transport of the conveyor 1. In the illustrated example, the housing 2 is a circular tube, however as is known in the art, other tubular or housing forms may be used, including square tubes, rectangles, or open carriers. The housing 2 provides confinement for the conveyed materials and a guard for operational safety. The return section 3 has within, the belt return support components, and provides support structure for those components and a guard for operational safety. A baffle 9 at the infeed end 4 regulates material being gathered on the belt and into the housing 2 in order to prevent clogging.

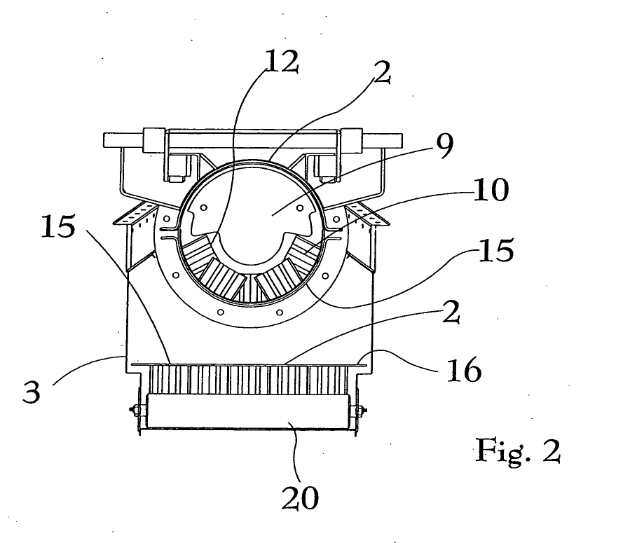

The belt 10, FIG. 2, is preferably a molded synthetic rubber belt having a plurality of lugs 12 which are arranged or arrayed in a cooperating relationship of angled elements that form material receiving pockets, the concept being to prevent or substantially inhibit the rearward slide of grain or conveyed materials when the conveyor 1 is at a high angle. The lugs 12 are preferably molded in place with the belt 10 rather than being separate elements bonded or mechanically affixed to the planar belt structure. The lugs are preferably approximately two inches in height and are formed of a series of steps forming a taper to allow separation from the mold cavity. The illustrated lugs 12 are U shaped and have diverging legs that overlap with the leg of an adjoining lug 12 to form a honeycomb appearing structure. The lugs or cleats 12 may be of the same size or different sizes, as illustrated, they are the same size. The lugs 12 are shown in a staggered relationship that results in arms 13 overlapping longitudinally and transversely.

Thus it will be understood that seed that would otherwise tend to backflow or roll downward when the conveyor 1 is at a high angle in the order of 40 degrees would be trapped by the lugs and prevented from longitudinal or transverse movement. The significant lug height of approximately two inches allows great carrying capacity, as does the mutual overlapping arrangement of the lugs 12. The lugs 10 are arranged in longitudinal rows staggered vertically from the adjoining longitudinal row. The lugs 10 are also arranged in transverse rows staggered horizontally from the adjoining transverse row. The resultant arrangement of the lugs 12 not only efficiently traps grain from sliding backward, but also provides a substantially even constant contact surface longitudinally and transversely across the tops of the lugs 12 for a smooth return of the conveyor belt 10 as will be explained below.

In the manufacture of the belt 10, preferably the belt underside 15 is fabric and is left free of rubber coating for minimal sliding friction in the housing 2. Also preferably, upper edges or margins 16 on the surface having the lugs 12 fabric and are rubber coating free, also for minimal friction when sliding over supports in the return section 3.

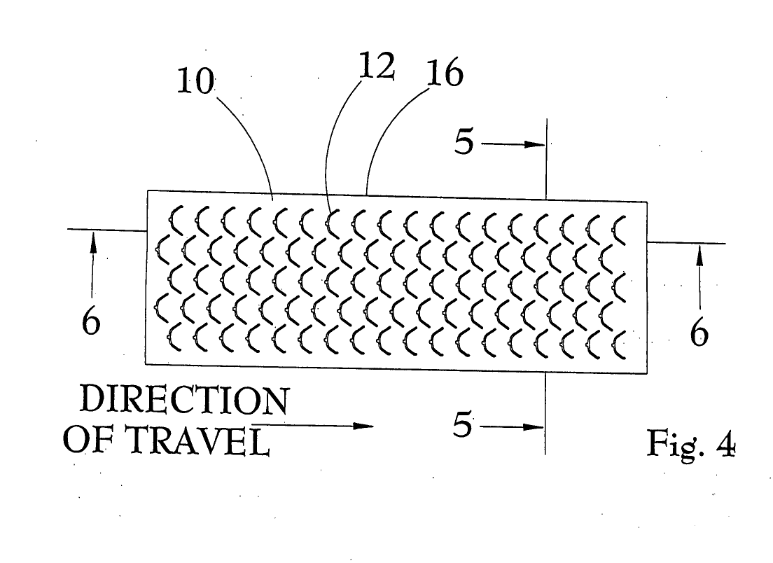

Within the conveyor housing 2 adjacent the infeed end 4, the housing has a transition section for transitioning the belt 10 from a flat form to a trough form with edges or margins curled inwardly. The trough configuration increases carrying capacity over a flat form conveyor. As will be seen, the inwardly curled edges of the belt 10 curl the attached lugs 12 inwardly, and the staggered relationship of the lug array insures that the individual lugs 12 do not bind against or interfere with each other. FIG. 4 shows a transverse sectional view across the conveyor return section 3. To support the return of the belt 10, the return section 3 has a series of belt supporting elements spaced along its length. In the illustrated example, these elements are large diameter rollers 20, such as six inch diameter, extending transversely across the section 3. The belt lugs 12 are staggered longitudinally and transversely so that the lug ends are in constant low friction rolling contact with the rollers 20. The smoothness of operation provided by the staggered relationship of the lugs 12 provides for longevity of the belt and a low friction substantially vibration free operation of the conveyor 1. Shelf elements 22 along the length of the section 3 form longitudinal edge supports upholding the belt margins.

The honeycomb configuration cleated belt conveyor arrangement utilizes a novel lug array which enables the user to provide a belt conveyor capable of high angle grain moving capability. Previous cleated belts were capable of high capacity or high angle but not both. For example, a 60 foot unit may perform up to 6000 bu/hr at a 30 degree angle but not at 33 degrees. Initial tests on the belt conveyor arrangement of this invention has demonstrated successful operation of 6000 bu/hr at 35 degrees using a 10 inch interior diameter conveyor.

What is claimed and desired to protect by Letters Patent is:

1. A conveyor for transport of granular materials comprising:
a. an elongate housing having an interior trough, a bottom return section, an infeed end and a discharge head;
b. a conveyor belt running through said housing and nested in said trough, and returning through said return section, the belt having an array of upwardly projecting lugs having cooperating angled elements forming material receiving pockets, the lugs being arranged on said belt in cooperating relationship as said belt curls laterally in said trough so as to inhibit backflow of materials when said conveyor is running;
c. the conveyor bottom return section having a plurality of belt supporting elements extending transversely across said return section, said lugs being further arrayed so that upper ends of said lugs provide a longitudinally and transversely constant supportive surface for low friction running support by said belt supporting elements.

2. The conveyor set forth in claim 1 wherein said lugs on said belt are formed integrally with said belt and are not separately attached thereto.

3. The conveyor set forth in claim 2 wherein said lugs on said belt project upwardly approximately 2 inches.

4. The conveyor set forth in claim 1 wherein said belt has a rubber upper surface and a fabric lower surface and having fabric margins for low friction running support.

5. A conveyor for transport of granular materials comprising:
a. an elongate enclosed housing having an interior trough, a bottom return section, an infeed end and a discharge head;
b. a conveyor belt having a rubber top and cloth edges and bottom, the belt running through said return section and having an array of upwardly projecting lugs forming material receiving pockets, the lugs having legs with overlapping transverse and longitudinal sections providing constant support areas, the lugs being arrayed on said belt in cooperating honeycomb relationship as said belt curls laterally in said trough so as to inhibit backflow of materials when said conveyor is running;
c. the conveyor bottom return section having a plurality of belt supporting rollers extending transversely across said return section, said rollers contacting the belt across the lug legs constant support areas for providing low friction running support; and
d. the conveyor bottom return section further having longitudinal edge supports engaging the belt cloth edges for low friction running support.
